(19) United States
(12) Patent Application Publication
(10) Pub. No.: US 2023/0173794 A1
(43) Pub. Date: Jun. 8, 2023

(54) POLYMER FOAM LAMINATE STRUCTURE

(71) Applicant: BASF SE, Ludwigshafen am Rhein (DE)

(72) Inventors: Patrick Spies, Ludwigshafen (DE); Daniela Longo-Schedel, Ludwigshafen (DE); Rene Holschuh, Ludwigshafen (DE); Xaver Hopfenspirger, Ludwigshafen (DE)

(21) Appl. No.: 17/998,985

(22) PCT Filed: May 17, 2021
(86) PCT No.: PCT/EP2021/063015

§ 371 Date: Nov. 16, 2022

(30) Foreign Application Priority Data
May 19, 2020 (EP) 20175448.8

(51) Int. Cl. B32B 27/06; B32B 5/20; B32B 27/08; B32B 27/34; B32B 15/08; B32B 27/32; B29C 44/04

(52) U.S. Cl. CPC B32B 27/065; B32B 5/20; B32B 27/08; B32B 27/34; B32B 15/08; B32B 27/32; B29C 44/04; B32B 2250/05; B32B 2250/40; B32B 2307/72

(57) ABSTRACT

The present invention relates to a polymer foam laminate structure (1), comprising—a first solid layer (101) having a density of more than 1000 g/l, which is covered by at least one first functional layer (103), —a polymeric foam layer (105) provided on the at least one first functional layer (103), —a second solid layer (109) having a density of more than 1000 g/l, which is covered by at least one second functional layer (107), the at least one second functional layer (107) being in contact with the polymeric foam layer (103), wherein the polymeric foam layer (105) has a density of 20 g/l to less than 1000 g/l. The present invention further pertains a method for preparing a polymer foam laminate structure (1) and a composite component (1000) inter alia comprising the polymer foam laminate structure (1).

The present invention relates to a polymer foam laminate structure as well as a method for preparing the same. The present invention further is related to the use of the polymer foam laminate structure as well as a composite component comprising inter alia the polymer foam laminate structure according to the present invention.

Today, requirements to engineering materials for instance for aviation industry, automobile industry and naval industry are directed to materials having low weight while at the same time insuring stiffness, stability as well as strength. In particular, in applications of energy absorbing materials, thermoplastic foams having high density can show high energy absorption insuring dynamic crash testing.

Generally, the use of such foams is known in the prior art, for instance from DE 10 2018 111 510 A1, wherein an energy absorbing device is disclosed comprising a tube like element which is filled with a first type of pellets and a second type of pellets wherein the first type of pellets are deformable with regard to the second type of pellets. For the first type pellets a foam like material as polystyrene can be used while the stiffer second type pellets can be made of polyvinyl chloride. The energy absorption takes place within the tube-like vessel.

Another prior art, EP 3 272 798 A1, generally relates to polyamide resin foam moulded articles and a method for producing the same. Such articles are described to be adopted for insulating materials and automotive components like engine or cylinder head covers, body structures and electrical equipment cases.

U.S. Pat. No. 5,746,537 describes polymeric closed cell foams as crash-absorbing elements in vehicles. Thermoplastic foams like PVC, PU and PS are described. An adhesion to a metal surface is not described.

However, when adopting thermoplastic foam materials for energy absorbing components, the prior art has not provided a satisfying solution for joining the foam with the known structural materials like steel or aluminium or reinforced plastic.

The objective problem underlying the present invention is therefore seen in the provision of a novel polymer foam laminate structure which overcomes to drawbacks of the prior art and which in particular provides a sufficient joining of a polymeric foam material to a solid construction material. Another task of the present invention is to provide a method for preparing such a polymer foam laminate structure.

The above-mentioned problems are solved according to the present invention in a first aspect by a polymer foam laminate structure (1), comprising
a first solid layer (101) having a density of more than 1000 g/l, which is covered by at least one first functional layer (103),
a polymeric foam layer (105) provided on the at least one first functional layer (103),
a second solid layer (109) having a density of more than 1000 g/l, which is covered by at least one second functional layer (107), the at least one second functional layer (107) being in contact with the polymeric foam layer (103),

wherein the polymeric foam layer (105) has a density of 20 g/l to less than 1000 g/l.

Moreover, the above-mentioned task has been solved in a second aspect of the present invention by a method for preparing a polymer foam laminate structure (1), in particular according to any of claims 1 to 12, comprising the steps of
a1) providing a first solid layer (101),
a2) providing a second solid layer (101),
b1) providing at least one first functional layer (103) onto the first solid layer (101),
b2) providing at least one second functional layer (107) onto the second solid layer (109),
c) providing a polymeric foam layer (105) onto the at least one first functional layer (103) and beneath the at least one second functional layer (107), thereby attaining a pre-laminate structure,
d) pressing the pre-laminate structure at elevated temperature and
e) obtaining the polymer foam laminate structure (1).

By means of the present invention, well-known stiff construction materials like steel or aluminium or reinforced plastic can be thermally joined with a polymeric foam layer in order to result in the novel construction material. The invented polymer foam laminate structure (1) can be applied as an energy-absorbing member for instance in crash elements.

If polyamide is used as polymeric foam layer (105), the invented polymer foam laminate structure (1) can withstand high temperature during cathodic drip coating (e.g. curing oven 190° C.). On the other hand, the combination of a stiff layer (e.g. first solid layer (101), e.g. like metal) which is cohesive linked by the at least one first functional layer (103) to a stiff and tough polymeric foam (i.e. polymeric foam layer (105)), sandwich parts (i.e. polymer foam laminate structure (1)) with outstanding crash absorbing performance could be obtained. As will be shown below in the examples, no delamination or damage of the sandwich (i.e. polymer foam laminate structure (1)) occurs during crash or bending test.

The Invention is Described in Detail Below.

If features are mentioned in the following description of the polymer foam laminate structure (1) according to the invention, they also refer to the method according to the invention as described herein. Likewise, features which are mentioned in the description of the method according to the invention also refer to the polymer foam laminate structure (1) according to the invention.

In a first aspect, the present invention relates to a polymer foam laminate structure (1), comprising
a first solid layer (101) having a density of more than 1000 g/l, which is covered by at least one first functional layer (103),
a polymeric foam layer (105) provided on the at least one first functional layer (103),
a second solid layer (109) having a density of more than 1000 g/l, which is covered by at least one second functional layer (107), the at least one second functional layer (107) being in contact with the polymeric foam layer (103),

wherein the polymeric foam layer (105) has a density of 20 g/l to less than 1000 g/l.

The term “solid layer” as used herein is to be understood in the sense of the present invention that this particular layer(s) is/are made of a solid material having essentially no porosity, which is in contrast to the term “polymeric foam layer” showing a remarkable porosity. In order to draw a sharp between both terms, the density of more or less than 1000 g/l is given.

The density of the polymeric foam layer (105) is determined according to DIN EN ISO 845-10:2009, the density of the first and second functional layers (103, 107) is determined according to DIN EN ISO 1183.

In order to enhance the joint between the first solid layer (101) and the polymeric foam layer (105), at least one first functional layer (103) covers the first solid layer (101), which in particular serves as a bonding layer. Similarly, the second solid layer (109) is covered by at least one second functional layer (107) being in contact with the polymeric foam layer (103).

According to the present invention, the first and second functional layers (103, 107) are a tool to obtain a force-locking connection between the first and second solid layers (101, 109) and the polymeric foam layer (105).

In particular, the first and second functional layers (103, 107) comprise an unreinforced polymer, which is particularly suitable for creating good adhesion to the surface of the first and second solid layers (101, 109) due to the chemical structure (polyamide). Because the first and second functional layers (103, 107) are highly elastic, tensions during forming or bending between the polymeric foam layer (105) and the first and second solid layers (101, 109) can be compensated. In addition, stresses resulting from the different thermal expansion coefficients of the first and second solid layers (101, 109) and the polymeric foam layer (103) can be absorbed.

The present invention gives rise to the advantageous effect that well-known stiff construction materials as the first and second solid layers (101, 109) (like steel, aluminium, reinforced plastic) can be thermally joined with the polymeric foam layer (103) in order to result in the novel construction material, namely the invented polymer foam laminate structure (1).

Further advantages are the use of light-weight materials, this is the incorporation into the vehicle body from metal. The metal (e.g. for solid layer (101, 109)) is covered with a first and second functional layer (103, 107) and then converted with standard steel processing techniques like deep drawing. The particle foam for the polymeric foam layer (105) can either directly converted on the first and second functional layers (103, 107) in a mould with hot steam (lamination and fusing of prefoamed particle in one step). Or a particle foam part for the polymeric foam layer (105) is laminated on the first and second functional layers (103, 107) with heat.

In contrast for instance to U.S. Pat. No. 5,746,537, the present invention enables to combine stiff polymeric foams with a metal car body, which in addition can withstand high temperatures which would occur for instance during cathodic drip coating.

In a particular embodiment of the invented polymer foam laminate structure (1), the polymer foam is obtained from welding of prefoamed thermoplastic particles with steam, IR irradiation or microwaves. The prefoamed thermoplastic particles comprise thermoplastic polyurethane (TPU) (in particular “Infinergy 100 HD” of BASF SE), or polyamide (PA6, PA12, PA6.12, PA6.12, PA6/6.36, polyether blockcopolyamides, PA66, PA6T/66, PA6I/6T, PA6T/6I, PA9T, TPU and mixtures thereof (in particular the copolyamide PA6/6.36 “Ultramid® Flex F 38” and lends of PA6/6.36 and polyamide 6 of BASF SE, density 1060 kg/m³-1090 kg/m³, relative viscosity (RV) 3.7-3.9, melting point 199° C.)

In a further development of the invented polymer foam laminate structure (1), the first and second functional layers (103, 107) are thermoplastic layers which comprise polyamide, thermoplastic polyurethane, hotmelts or combinations thereof.

The first and second functional layers (103, 107) are preferably thermoplastic and compatible with the surface of the first and second solid layers (101, 109). They have a melting point or softening point of <250° C. The materials used are preferably polyamide (especially PA6, PA6/6.36, PA6/66, PA12, PA6.12, PA6.10, PA6I/6 T, copolymers of caprolactam or lauryllactam), thermoplastic polyurethane (TPU), and hotmelts and polyether block copolyamides.

The expression “hotmelts”, as used herein, is to be understood as designating solvent-free or water-free products which are more or less solid at room temperature, which are present in the hot state as a viscous liquid and are applied to the adhesive surface. On cooling they solidify reversibly and produce a firm bond. This group of adhesives are thermoplastic polymers based on different chemical raw materials. The main polymers used for these physically setting hot melt adhesives are polyamide resins, saturated polyesters, ethylene-vinyl acetate (EVA) copolymers, polyolefins, block copolymers (styrene-butadiene-styrene or styrene-isoprene-styrene) and polyimides. Polyamides, polyesters and polyimides are used in so-called high-performance hot-melt adhesives, while ethylene-vinyl acetate copolymers and polyolefins in so-called mass-melt adhesives.

The first and second functional layers (103, 107) can also contain other functional additives such as plasticizers or functional polymers such as maleic anhydride grafted copolymers of polyethylene and α-polyolefins or MA grafted copolymers of polyethylene and acrylic acid esters.

According to the present invention it can be useful to increase the toughness and elasticity of the functional layer with the above-mentioned additives so that it can be better formed in the polymer foam laminate structure (1) and is not damaged.

In a further development of the present invention, the polymeric foam layer (105) has a softening point of 100° C. to 280° C.

The term “softening point” means in case of semi-crystalline polymers the melting temperature Tm, which can be determined by differential scanning calorimetry (DSC) according to DIN EN ISO 11357-3: 2014.

On the other hand, the term “softening point” means in case amorphous polymers the glass transition temperature Tg, which can be determined by differential scanning calorimetry (DSC) according to DIN EN ISO 11357-2: 2014 at a heating rate of 20 K/min.

It is preferred according to the present invention, when the polymeric foam layer (105) is obtainable by
fusing of pre-foamed polymeric particles, or
extruding a thermoplastic polymer in the presence of a blowing agent through a slot die, or
loading a thermoplastic polymer above the softening temperature with a blowing agent in an autoclave, followed by expansion and moulding
using a foam injection moulding machine,
direct fusing of prefoamed polymeric particles on the first and second functional layers (103, 107) with steam in a special mould

The method of “fusing” comprises steam chest moulding, steam-less moulding techniques, gluing and/or other connection technologies like Atecarma® technology (of Teubert Maschinenbau GmbH).

In a particular embodiment, the polymeric foam of the polymeric foam layer (105) may be open-celled or closed-celled.

It is preferred invented polymer foam laminate structure (1) when the polymeric foam layer (105) comprises a polyamide, a thermoplastic polyurethane, polyether block copolyamide, polypropylene, polystyrene, polyethylene terephthalate (PET), polybutylene terephthalate (PBT), polyester/polylactide (PLA), polyether sulfones (PESU) and mixtures thereof.

Polyamides can advantageously combine high stiffness, toughness and thermal stability.

Moreover, it is preferred for the invented polymer foam laminate structure (1) when the at least one first functional layer (103) and/or the at least one second functional layer (107) comprises a polyamide, in particular PA6, PA6/6.36; PA12, PA610. Pa6/66, PA6.12, polyether block copolyamide.

Polyamides advantageously show a god adhesion behaviour to acrylate primered metal surfaces.

In the invented polymer foam laminate structure (1), the at least one first functional layer (103) and/or the at least one second functional layer (107) may further comprise a homo polymer or a copolymer of ethylene and/or α-olefins and/or acrylic acid esters and/or maleic anhydride.

The homo polymer or the copolymer acts as an impact modifier for the first and second functional layers (103, 107) and increase the elongation at break, so that a metal part (i.e. solid layer (101, 109) on which the first and second functional layers (103, 107) is already laminated can be converted with deep drawing techniques without destroying the first and second functional layers (103, 107).

In particular, the homo polymer or the copolymer may be grafted with maleic anhydride.

The grafting with maleic anhydride increases the compatibility of the homo polymer or copolymer to polyamide.

In order to ensure a sufficient joint in the invented polymer foam laminate structure (1) the at least one first functional layer (103) and/or the at least one second functional layer (107) have a thickness between 20 μm and 2000 μm.

This thickness can be measured by a slide gauge ultrasonic.

The functional layer must have a certain thickness to ensure that the space on the uneven surface of a particle foam part (i.e. polymeric foam layer (105)) is filled with the polymer of the first and second functional layers (103, 107) (typically 400 μm-1000 μm). On the other hand, if the polymeric foam of the polymeric foam layer (105) has a smooth surface (like foams from die extrusion) the thickness of the first and second functional layers (103, 107) can be reduced.

The first and second functional layers (103, 107) can each be produced using standard thermoplastic production techniques (casting calander) and then laminating them onto the first and second solid layers (101, 109), respectively, for instance by a coil coating line or a hot press, by a interval hot press or a double belt press.

In a first alternative embodiment of the present invention, the first solid layer (101) and/or the second solid layer (109) is a metal layer, preferably having a thickness between 150 μm and 2000 μm. This is a typical thickness metal roll goods.

In a second alternative embodiment of the present invention, the first solid layer (101) and/or the second solid layer (109) is a solid polymer layer, preferably having a thickness between 1 mm and 10 mm. There are typical thicknesses which are realisable by injection moulding.

According to the second alternative embodiment of the invented polymer foam laminate structure (1), the solid polymer layer as the first solid layer (101) and/or the second solid layer (109) comprises a polymeric material reinforced by carbon fibre, glass fibre, aramid fibre, basalt fibre, natural fibre, metal fibre, potassium titanate particles and mixtures thereof.

In particular, the reinforcing fibres can be incorporated as roving or cut, continuous fibres in the usual commercial form. Furthermore, woven fabrics, scrims, float, mats and staple fibres made of the above-mentioned reinforcing materials can also be used.

From the viewpoint of mechanical stability, it is particularly preferred for the invented polymer foam laminate structure (1) when the first solid layer (101) is in force-locking contact with the at least one first functional layer (103) and the second solid layer (109) is in force-locking contact with the at least one second functional layer (107).

The above-mentioned task is attained in a second aspect of the present invention by a method for preparing a polymer foam laminate structure (1), in particular as describe above, comprising the steps of
a1) providing a first solid layer (101),
a2) providing a second solid layer (101),
b1) providing at least one first functional layer (103) onto the first solid layer (101),
b2) providing at least one second functional layer (107) onto the second solid layer (109),
c) providing a polymeric foam layer (105) onto the at least one first functional layer (103) and beneath the at least one second functional layer (107), thereby attaining a pre-laminate structure,
d) pressing the pre-laminate structure at elevated temperature and
e) obtaining the polymer foam laminate structure (1).

The invented method according to the present invention principally has the same advantageous effects as given above for the invented polymer foam laminate structure (1). Well-known stiff construction materials as the first and second solid layers (101, 109) can be thermally joined with the polymeric foam layer (103) in order to result in the novel construction material. For this manufacture, common devices can be used and moderate preparation conditions can be applied.

This method for preparing a polymer foam laminate structure (1) can be modified in a very particular embodiment by comprising the steps of
a1) providing a first solid layer (101),
b1) providing at least one first functional layer (103) onto the first solid layer (101),
c1) providing prefoamed thermoplastic beads of the polymeric foam material for the polymeric foam layer (105), the thermoplastic beads having a raw density of 200 g/l to 400 g/l,
d1) providing a polymeric foam layer (105) by direct fusing of the prefoamed beads onto the at least one first functional layer (103) with hot steam or heat irradiation (IR) and
e) obtaining the polymer foam laminate structure (1).

The invented method is described in more detail below when referring to a specific embodiment.

Another aspect of the present invention pertains the use of the invented polymer foam laminate structure (1) as detailed above as an energy-absorbing device.

As will be shown by means of examples according to the present invention and comparative examples, the invented polymer foam laminate structure (1) is particularly applicable as an energy-absorbing device when provided in a crash element, for instance.

Finally, a very specific aspect of the present invention refers to a composite component (1000), comprising
a polymer foam laminate structure (1) according to the present invention and as detailed above,
at least one polymeric layer (1003) provided either on the first solid layer (101) or on the second solid layer (109) of the polymer foam laminate structure (1) and
a metallic layer (1001) provided on the at least one polymeric layer (1003) opposite of the polymer foam laminate structure (1) according to any of claims 1 to 12,

wherein the at least one polymeric layer (1003) comprises an intumescent material.

In other words, the invented polymer foam laminate structure (1) is added by another functionality, namely a flame and heat protection.

In order to attain this additional functionality, the metallic layer (1001) is arranged to face the heat source like a flame. It is preferred for the metal layer (1001) to have a thickness of 0.1 mm to 2 mm. As the metal of the metallic layer (1001), steel, galvanised (hot-dip or electroplated) steel, aluminium, zinc, tin, copper, chrome, magnesium or alloys thereof may be applied. Especially suitable are metals or alloys with a melting point <900° C., especially aluminium and zinc.

In particular, the metallic layer (1001) may be pre-treated with an adhesion promoter/primer based on polyacrylates or polymethacrylates, polyvinyl amines, phosphoric acids, polyphosphoric acid; copolymers of maleic acid and acrylic acid and/or methacrylic acids and/or ester of acrylic or methacrylic esters, copolymers of maleic and styrene, copolymers of ethylene and acrylic acid and/or methacrylic acids and/or esters of acrylic or methacrylic esters and/or maleic acid and polyvinylpyrrolidone, to ensure good bonding to the at least one polymeric layer (1003). The adhesion promoter is typically applied as aqueous solution via roll coating.

The at least one polymeric layer (1003) is provided on the metallic layer (1001) which is to be understood in the sense of the present invention that those layers ((1001), (1003)) are preferably completely and tightly in contact with each other.

The either first solid layer (101) or second solid layer (109) of the invented polymer foam laminate structure (1) is provided on the at least one polymeric layer (1003) on the opposite side of the metallic layer (1001). In other words, the metallic layer (1001) and the either first solid layer (101) or second solid layer (109) are sandwiching the at least one polymeric layer (1003).

The at least one polymeric layer (1003) comprises as its particular feature an intumescent material.

The expression “intumescent material” relates according to the present invention to a material that swells or expands as a result of heat exposure. This swelling or expanding leads to an increase in volume and decrease in density. In the present invention, the intumescent material serves for absorbing at least in part the heat of the heat source.

The metal-polymer laminate structure (1) according to the present invention exhibits an excellent flame protection to any component which is located on the rear side, this is on the side of the invented polymer foam laminate structure (1).

As has been shown in the examples of another application of the present applicant, in case of a severe heat/flame exposure the metallic layer (1001) may melt or burn-through locally, while the intumescent material comprised in the at least one polymeric layer (1003) starts intumescing and thereby squeezing out of the opening in the metallic layer (1001). While intumescing and squeezing out of the metallic layer (1001), the intumescent material serves for an effective heat isolation of the backing layer (105), which in turn protects any component on the rear side this is on the side of the invented polymer foam laminate structure (1), against the high temperatures of the heat source.

The insulating effect results from the intumescent material, e.g. expanded graphite, which repeatedly foams from the surface into the damaged area and renews the intumescent material layer, e.g. expanded graphite layer, damaged by the flame. The the invented polymer foam laminate structure (1) on the rear side has above all a structural function.

In order to enhance the joint between the metallic layer (1001) and the at least one polymeric layer (1003), therebetween another functional layer is interposed which in particular serves as a bonding layer.

Further aims, features, advantages and possible applications result from the following description of preferred embodiments not restricting the invention by means of the figures. All described and/or pictorially depicted features, on their own or in any combination, form the subject matter of the invention, even independently of their summary in the claims or their retrospective relationship. In the Figures

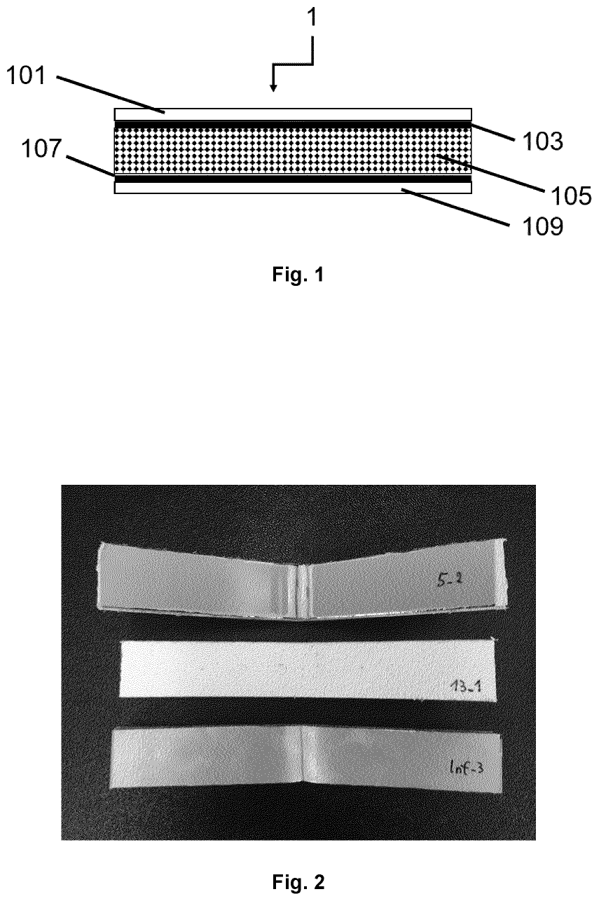

FIG. 1 depicts a schematic view of the polymer foam laminate structure 1 according to an embodiment of the invention,

FIG. 2 is a picture of examples and comparative examples regarding the polymer foam laminate structure 1,

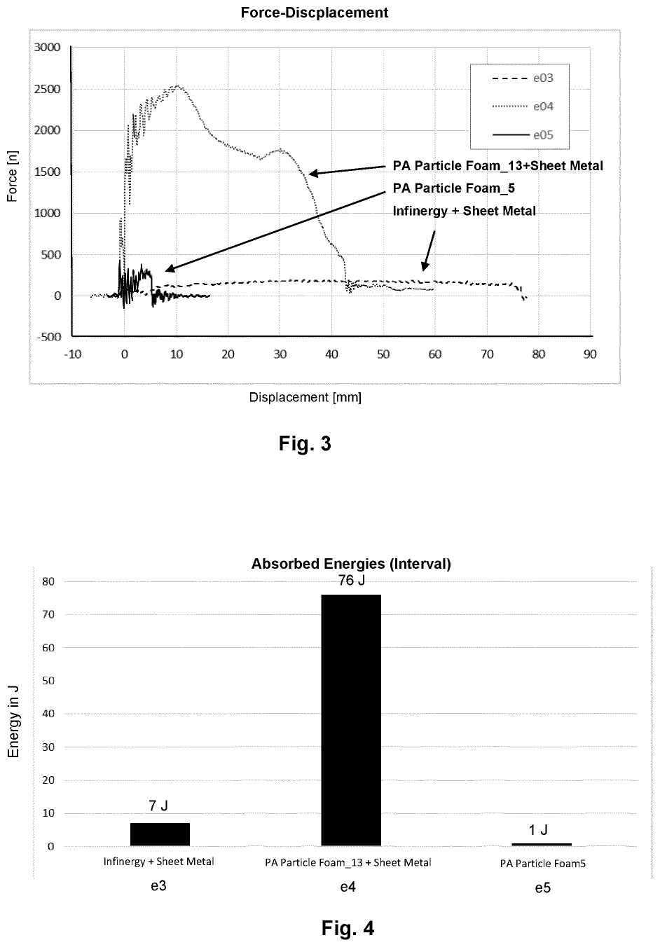

FIG. 3 is a graph of a force-displacement curve for the examples and comparative examples of FIG. 2,

FIG. 4 is a graph of absorbed energies for the examples and comparative examples of FIG. 2,

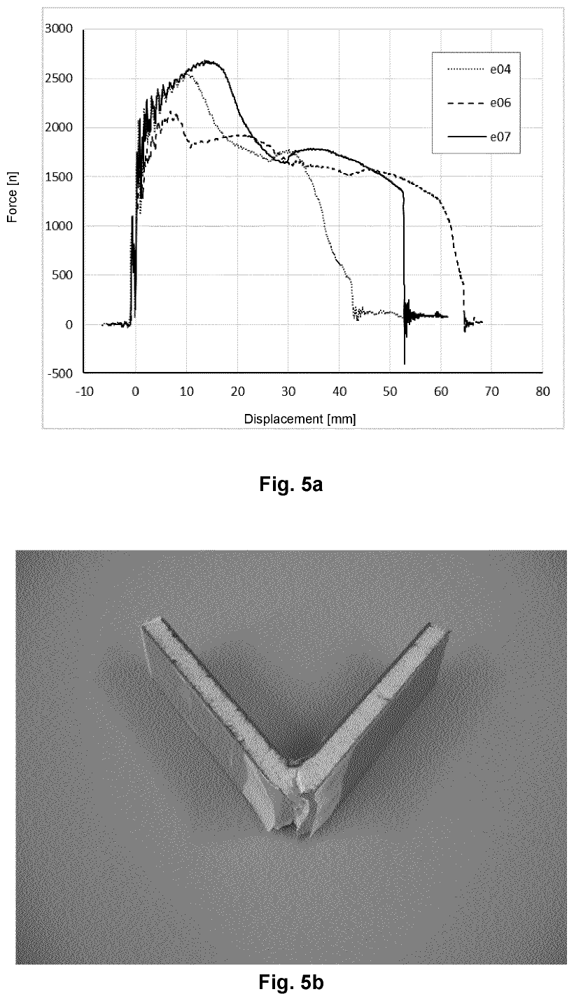

FIG. 5a is a graph of a force-displacement curve for a test specimen “PA particle foam 13”,

FIG. 5b is a picture of the test specimen underlying the graph of FIG. 5a,

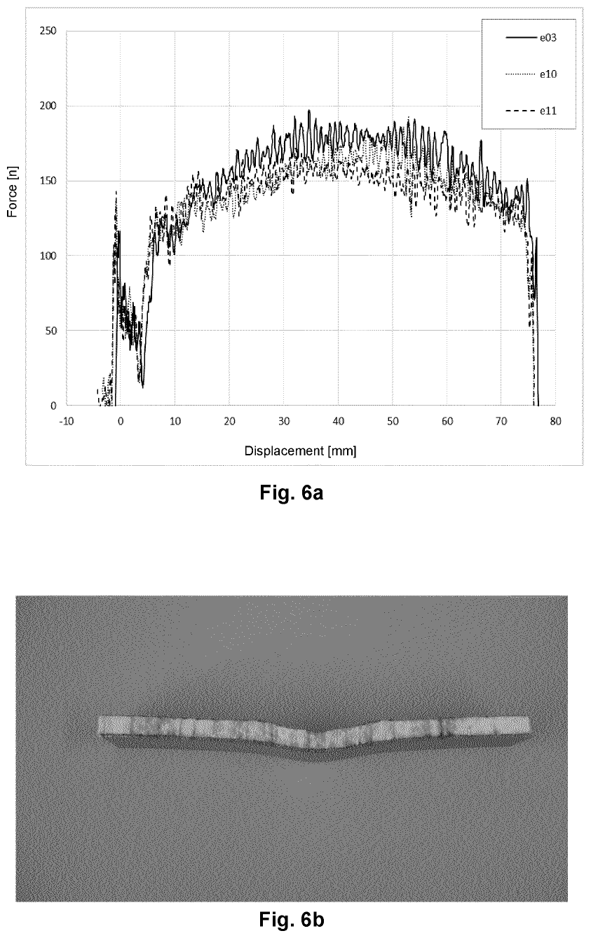

FIG. 6a is a graph of a force-displacement curve for a test specimen “TPU foam”,

FIG. 6b is a picture of the test specimen underlying the graph of FIG. 6a,

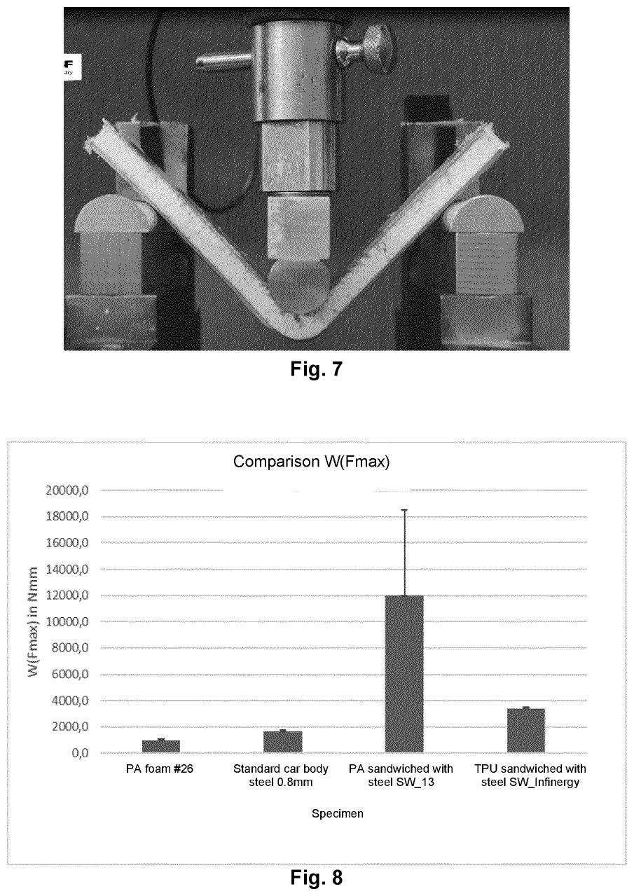

FIG. 7 is a picture of a testing setup with a test specimen according to the invention inserted, and

FIG. 8 is a graph comparing the bending work.

In FIG. 1 a schematic overview of the polymer foam laminate structure 1 according an embodiment of the invention is given. On the top and on the bottom both the first solid layer 101 and the second solid layer 109 are shown. Both these layers are provided with the at least one first functional layer 103 and the at least one second functional layer 107, respectively, towards the inner. In between, the polymeric foam layer 105 is arranged.

Experiments

Production of the Invented Polymer Foam Laminate Structures 1

The polymers listed in Table 1 were compounded with a ZE 25A UXTI twin-screw extruder in the quantities shown in Table 1 to form cylindrical pellets. The resulting pellets (PZ1 and PZ2) were then extruded into films using a cast calander extruder. The films had a thickness of 400 μm and a width of 40 cm. The quantities given in Table 1 are each in weight-%.
P1: Polyamid 6 (Ultramid B24N of BASF SE)
P2: PA6/6.36 (Ultramid Flex F29 of BASF SE)
Co1: low density ethylene/n-butylacrylate copolymer (Lucalen A2540 D of Basell)
Co2: ethylene propylene copolymer, grafted with maleic anhydride_(Exxelor 1801 of Exxon Chemicals)
A1: N, N′-1,6-hexanediylbis [3,5-bis-4-hydroxyphenylpropanamide] (Irganox B 1171 2x20KG 4G of BASF SE)
A2: Talcum

TABLE 1
polymer compositions

| | | PZ1 | PZ2 |
|---|---|---|---|
| P1 | [wt.-%] | 59.1 | |
| P2 | [wt.-%] | | 86.1 |
| Co1 | [wt.-%] | 25 | |
| Co2 | [wt.-%] | 15 | 10 |
| A1 | [wt.-%] | 0.5 | 0.5 |
| A2 | [wt.-%] | 0.4 | 0.4 |

TABLE 2
sheets used

| | | sheet 1 | sheet 2 |
|---|---|---|---|
| PZ 1 | [wt.-%] | 100 | |
| PZ 2 | [wt.-%] | | 100 |
| thickness sheet [μm] | | 400 | 400 |

The sheets described in Table 2 were then consolidated with pretreated metal tapes as the first and second solid layers 101, 109 in a heatable press to form laminates. Metal tape and sheet were cut to the following dimensions: 300 mm×200 mm. The temperatures given in Table 3 were used. Sheet 1 and sheet 2 were pre-dried overnight with dry air at 80° C. First of all, scrims are produced, which were placed in the cold press together with a spacer in the respective target thickness. The press was closed with a contact pressure of 100 kN and heated to the target temperature given in Table 3. The temperature was held for 60 s, then the press was cooled to 50° C. and the laminate was removed.

The following metal tapes and polymeric tapes were used as the first and second solid layers 101, 109:
M1 galvanized steel pretreated with an aqueous solution of phosphoric acid and acrylic acid (Gardobond X4543 of Chemetal GmbH) via roll coating, thickness of the metal sheet: 250 μm
M2 aluminium pretreated with an aqueous solution of phosphoric acid and acrylic acid solution (Gardobond X4595 of Chemetal GmbH) via roll coating, thickness of the metal sheet: 300 μm
K1: injection-moulded tape (10 mm×10 mm×2 mm) made of polyamide PA6-GF35 (Ultramid B3EG7 sw 564 from BASF SE)

In particular, the first and second solid layers 101, 109 may be pre-treated with an adhesion promoter/primer based on polyacrylates or polymethacrylates, polyvinyl amines, phosphoric acids, polyphosphoric acid; copolymers of maleic acid and acrylic acid and/or methacrylic acids and/or ester of acrylic or methacrylic esters, copolymers of maleic and styrene, copolymers of ethylene and acrylic acid and/or methacrylic acids and/or esters of acrylic or methacrylic esters and/or maleic acid and polyvinylpyrrolidone, to ensure good bonding to the first and second functional layers 103, 107. The adhesion promoter is typically applied as aqueous solution via roll coating.

TABLE 3
laminates obtained

| | | | | overall |
|---|---|---|---|---|
| | | | | thickness |
| | | | lamination | after |
| | ply 1 | ply 2 | temperature | pressing |
| laminate 1 | M1 | sheet 1 | 250 | 400 μm |
| laminate 2 | M1 | sheet 2 | 220 | 400 μm |
| laminate 3 | M2 | sheet 1 | 250 | 450 μm |
| laminate 4 | M2 | sheet 2 | 220 | 450 μm |
| laminate 5 | K1 | sheet 1 | 250 | 2100 μm |
| laminate 6 | K1 | sheet 2 | 220 | 2100 μm |

The laminates described in Table 3 were pressed into polymer foam laminate structure (PFLS). The polymeric foam layers PSP1 to PSP3 mentioned below in Table 4 were used as the core layers. The side provided with the functional layer was laminated to the top and bottom side of the polymeric foam layers 105.

The polymeric foam layers can be produced with all fusing methods known to the expert. More precisely described is the production in an automatic moulding machine based on steam technology. But also water-free methods such as radio frequency fusing by the Kurz company or the Variotherm process by the Fox Velution company are conceivable.

As the pre-foamed polymeric foam layers comprising TPU the product Infinergy 100 HD of BASF SE was used.

The pre-foamed polymeric foam layers comprising PA were produced as follows.

A melt impregnation was carried out in an apparatus consisting of a twin-screw extruder, divided into eight zones of equal length (Z1 . . . Z8), of the company Leistritz with an 18 mm screw diameter and a length to diameter ratio of 40, a melt pump, a start-up valve, a melt filter, a perforated die plate and an underwater pelletizer.

Polyamides together with talcum in a polyethylene bag were mixed and were feed in the twin screw extruder via a dosage unit. In the ⅓ of the extruder the polyamide was melted. After approximately ⅓ of the length of the extruder, the propellant was pumped with the aid of isco pump (piston pumps of the firm Axel Semrau) and was injected into the extruder. In the remaining part of the extruder the polymer melt was cooled by means of the temperature control of the twinscrew extruder. The temperature of the polymer melt, when passing through the perforated plate, corresponded to the temperature set at zone 8. By means of the melt pump the pressure profile in the extruder was set in such a way (pressure-speed control) that the blowing agent was completely mixed into the polymer melt. In addition to setting the pressure profile in the twin screw extruder, the melt pump also serves to convey the blowing agent and pressed the polymer melt is through the following devices (the start-up valve, the melt screen and the perforated plate). The melt strand emerging through the perforated plate (1 hole with a diameter of 1 mm) was introduced into the underwater pelletizer with pressure to give expanded polyamine granules with a granule weight of approx. 3.5 mg. The total throughput of the extruder was kept constant at about 4 kg/h. The strand in the water box was cut by 6 blades attached to the blade ring. The blade ring rotates at about 3500 rpm, thereby producing expanded granulates with a granulate weight of 3.5 mg, which are transported by the water circuit from the perforated plate into the drier and are separated into a collecting container.

For preparing PSP1, PSP2 and PSP4, the following composition was applied:

| | PSP1 | PSP2 | PSP4 |
|---|---|---|---|
| Polyamide (A) | | | |
| Polyamide 6 | 50 | 50 | |
| Polyamide 6I/6T | | | |
| Polyamide (B) | | | |
| Copolyyamide 6/6.36 | 50 | 50 | 100 |
| Nucleating agent | | | |
| Talk | 0.5 | 0.5 | 0.5 |
| Blowing Agent | | | |
| Nitrogen (N₂) | 0.2 | 0.2 | 0.2 |
| Carbon dioxide (CO₂) | 1.5 | 1.5 | 0.3 |
| Water | | | |
| Iso-pentane | | | |

The pre-expanded particles were loaded into the cavity of a mould by injection with compressed air (cavity dimensions: 300 mm in length, 200 mm in width and 25 mm in height). A certain mm of crack filling is applied for compressed particles. The mould was installed in a moulding machine. Thereafter, the pre-expanded particles were moulded by supplying saturated steam into the cavity for certain seconds (cross steam heating), and subsequently supplying saturated steam into the cavity for certain seconds (autoclave steam heating) via thermal fusion of the pre-expanded particles. Cooling water was supplied into the cavity of the mould for certain seconds to cool the resultant shaped and welded product. Process conditions and properties of the particle foam mouldings are compiled in Table 4.
PSP1: PA foam density 655 g/l, before pressing thickness: 10 mm before pressing
PSP2: PA foam density 590 g/l, thickness 25 mm before pressing
PSP3: TPU foam density 300 g/l, thickness 10 mm before pressing
PSP4: PA foam density 230 g/l, thickness 10 mm before pressing

TABLE 4
polymeric foam layers used

| | Particle | | | | Cross steam | | Autoclave | | | Part density |
|---|---|---|---|---|---|---|---|---|---|---|
| | bulk | Crack | | | heating | | steam heating | | Water | after drying |
| | density | filling | Time | Press. | Temp. | Time | Press. | Temp. | cooling | 70° C. |
| Example | [g/L] | [mm] | [s] | [bar] | ° C. | [s] | [bar] | [° C.] | [s] | for 16 h |
| PSP1 | 368 | 5 | 8 | 4 | 144 | 20 | 4 | 144 | 40 | 655 |
| PSP2 | 368 | 10 | 8 | 4 | 144 | 20 | 1.4 | 144 | 60 | 590 |
| PSP3 | 142 | 0 | 13 | 1.8 | 115 | 40 | 1.8 | 115 | 60 | 300 |
| PSP4 | 116 | 10 | 5 | 1.7 | 113 | 4 | 1.7 | 113 | 30 | 250 |

The polymer foam laminate structures described in Table 5 were produced by placing the layers listed in Table 5 in a hot press with a pressure of 10 kN and heating them to the lamination temperature given in Table 5. Polymer foam laminate structure (PFLS) were obtained with the respective total thickness shown in Table 5.

| | | | | | overall | |
|---|---|---|---|---|---|---|
| | | | | | thickness | |
| | | | | lamination | after | |
| | ply 1 | ply 2 | ply 3 | temperature | pressing | |
| PFLS 1 | laminate 1 | PSP1 | laminate 1 | 250 | 9 | mm |
| PFLS 2 | laminate 1 | PSP2 | laminate 1 | 250 | 24 | mm |
| PFLS 3 | laminate 2 | PSP1 | laminate 2 | 220 | 10 | mm |
| PFLS 4 | laminate 2 | PSP2 | laminate 2 | 220 | 25 | mm |
| PFLS 5 | laminate 3 | PSP1 | laminate 3 | 250 | 9 | mm |
| PFLS 6 | laminate 3 | PSP2 | laminate 3 | 250 | 24 | mm |
| PFLS 7 | laminate 4 | PSP1 | laminate 4 | 220 | 10 | mm |
| PFLS 8 | laminate 4 | PSP2 | laminate 4 | 220 | 25 | mm |
| PFLS 9 | laminate 3 | PSP3 | laminate 3 | 250 | 5 | mm |
| PFLS 10 | laminate 4 | PSP3 | laminate 4 | 220 | 10 | mm |
| PFLS 11 | laminate 5 | PSP1 | laminate 5 | 250 | 12 | mm |
| PFLS 12 | laminate 5 | PSP2 | laminate 5 | 250 | 12 | mm |
| PFLS 13 | laminate 6 | PSP1 | laminate 6 | 220 | 14 | mm |
| PFLS 14 | laminate 6 | PSP2 | laminate 6 | 220 | 14 | mm |

In case of PFLS 2, a slight collapsing of the foam could be observed.

FIG. 2 gives a picture of examples and comparative examples regarding the invented polymer foam laminate structure 1. The test specimen designated “5_2” is a PA particle foam sandwiched between metal layers (i.e. sheet metal) and the test specimen designated “13_1” is a PA particle foam which was used as the polymeric foam layer 103, while test specimen designated “Inf_3” is a TPU foam sandwiched between metal layers (i.e. sheet metal).

For the examples and comparative examples of FIG. 2, a graph of a force-displacement curve is shown in FIG. 3. It can be seen that the test specimen 5_2 (PA particle foam+sheet metal) shows high energy absorption and high stiffness, while the test specimen 13_1 (pure PA particle foam (PA Particle Foam 5) without sheet metal) shows only a low stiffness and therefore a low energy absorption. On the other hand, the test specimen Inf_3 (i.e. (Infinergy+sheet metal) has a very low stiffness but still high elasticity and shows a good energy absorption.

FIG. 4 shows a graph of absorbed energies for the examples and comparative examples of FIG. 2. As already known from FIG. 3, the test specimen 13_1 is superior compared to test specimen 5_2.

In FIG. 5a, a graph of a force-displacement curve for a test specimen test specimen 5_2 is shown in more detail, while FIG. 5b is a picture of the test specimen underlying this graph. The curves give an idea of the variation in energy absorbtion of different, but similar samples.

In FIG. 6a, a graph of a force-displacement curve for a test specimen TPU foam is shown in more detail, while FIG. 6b is a picture of the test specimen underlying this graph.

In FIG. 7, a testing setup is shown in which a test specimen according to the invention of polyamide sandwiched with steel is tested. Compared to standard car body steel this invented test specimen has the highest bending work, as shown in FIG. 8. There is no delamination and the foam core is almost intact.

### REFERENCE SIGNS

1 polymer foam laminate structure
101 first solid layer
103 first functional layer
105 polymeric foam layer
107 second functional layer
109 second solid layer
1001 metallic layer
1003 polymeric layer

1. A polymer foam laminate structure, comprising
a first solid layer having a density of more than 1000 g/l, which is covered by at least one first functional layer,
a polymeric foam layer provided on the at least one first functional layer,
a second solid layer having a density of more than 1000 g/l, which is covered by at least one second functional layer, the at least one second functional layer being in contact with the polymeric foam layer,
wherein the polymeric foam layer has a density of 20 g/l to less than 1000 g/l, and wherein the at least one first functional layer and/or the at least one second functional layer comprises a polyamide selected from PA6, PA6/6.36; PA12, PA610, Pa6/66, PA6.12, or polyether block copolyamide.

2. The polymer foam laminate structure according to claim 1, wherein the polymeric foam layer has a softening point of 100° C. to 280° C.

3. The polymer foam laminate structure according to claim 1, wherein the polymeric foam layer is obtainable by:
fusing of pre-foamed polymeric particles, or
extruding a thermoplastic polymer in the presence of a blowing agent through a slot die, or
loading a thermoplastic polymer above the softening temperature with a blowing agent in an autoclave, followed by expansion and moulding, or
using a foam injection moulding machine.

4. The polymer foam laminate structure according to claim 1, wherein the polymeric foam layer comprises a polyamide, a thermoplastic polyurethane, polyether block copolyamide, polypropylene, polystyrene, polyethylene terephthalate, polybutylene terephthalate, polyester/polylactide, polyether sulfones and mixtures thereof.

5. The polymer foam laminate structure according to claim 1, wherein the at least one first functional layer and/or the at least one second functional layer further comprises a homo polymer or a copolymer of ethylene and/or α-olefins and/or acrylic acid esters and/or maleic anhydride.

6. The polymer foam laminate structure according to claim 5, wherein the homo polymer or the copolymer is grafted with maleic anhydride.

7. The polymer foam laminate structure according to claim 1, wherein the at least one first functional layer and/or the at least one second functional layer have a thickness between 20 μm and 2000 μm.

8. The polymer foam laminate structure according to claim 1, wherein the first solid layer and/or the second solid layer is a metal layer, preferably having a thickness between 150 μm and 2000 μm.

9. The polymer foam laminate structure according to claim 1, wherein first solid layer and/or the second solid layer is a solid polymer layer, preferably having a thickness between 1 mm and 10 mm.

10. The polymer foam laminate structure according to claim 9, wherein the solid polymer layer as the first solid layer and/or the second solid layer comprises a polymeric material reinforced by carbon fibre, glass fibre, aramid fibre, basalt fibre, natural fibre, metal fibre, potassium titanate particles and mixtures thereof.

11. The polymer foam laminate structure according to claim 1, wherein the first solid layer is in force-locking contact with the at least one first functional layer and the second solid layer is in force-locking contact with the at least one second functional layer.

12. A method for preparing a polymer foam laminate structure, according to claim 1, comprising the steps of
a1) providing the first solid layer,
a2) providing the second solid layer,
b1) providing the at least one first functional layer onto the first solid layer,
b2) providing the at least one second functional layer onto the second solid layer,
c) providing the polymeric foam layer onto the at least one first functional layer and beneath the at least one second functional layer,
thereby attaining a pre-laminate structure,
d) pressing the pre-laminate structure at elevated temperature and
e) obtaining the polymer foam laminate structure.

13. A method for preparing a polymer foam laminate structure, according to claim 1, comprising the steps of
a1) providing the first solid layer,
b2) providing the at least one first functional layer onto the first solid layer,
c1) providing prefoamed thermoplastic beads of the polymeric foam material for the polymeric foam layer, the thermoplastic beads having a raw density of 200 g/l to 400 g/l),
d1) providing the polymeric foam layer by direct fusing of the prefoamed beads onto the at least one first functional layer with hot steam or heat irradiation and
e) obtaining the polymer foam laminate structure.

14. Use of the polymer foam laminate structure according to claim 1 as an energy-absorbing device.

15. A composite component, comprising
the polymer foam laminate structure according to claim 1,
the at least one polymeric layer provided either on the first solid layer or on the second solid layer of the polymer foam laminate structure and
a metallic layer provided on the at least one polymeric layer opposite of the polymer foam laminate structure,
wherein the at least one polymeric layer comprises an intumescent material.
